(19) United States
(12) Patent Application Publication
(10) Pub. No.: US 2023/0149256 A1
(43) Pub. Date: May 18, 2023

(54) WEARABLE LOCAL MUSCLE VIBRATORY STIMULATOR

(71) Applicants: The University of North Carolina at Chapel Hill, Chapel Hill, NC (US); North Carollna State University, Raleigh, NC (US)

(72) Inventors: Troy Blackburn, Chapel Hill, NC (US); Richard Lawrence Goldberg, Chapel Hill, NC (US); Jackson Richards, Raleigh, NC (US); Eric Nathan Markley, Oakland, CA (US); Ola Lars Anders Harrysson, Raieigh, NC (US); Harshad Srinivasan, Burnaby (CA); Vishnu Veeramachaneni, Fremont, CA (US)

(21) Appl. No.: 17/914,305

(22) PCT Filed: Mar. 31, 2021
(86) PCT No.: PCT/US2021/025207

§ 371 Date: Sep. 23, 2022

Related U.S. Application Data
(60) Provisional application No. 63/005,029, filed on Apr. 3, 2020.

(51) Int. Cl. A61H 23/02

(52) U.S. Cl. CPC A61H 23/0236; A61H 2201/165; A61H 2201/5043; A61H 2201/5076; A61H 2201/5084; A61H 2201/5097

(57) ABSTRACT

A wearable local muscle vibratory stimulator includes a frame including a concave surface for conforming to a treatment surface of a subject. The stimulator further includes an electromagnetic oscillator located in the frame for applying vibratory stimulus to a treatment region of the subject located beneath the treatment surface. The stimulator further includes a waveform generator coupled to the oscillator for generating an electrical signal that causes the electromagnetic oscillator to oscillate. The stimulator further includes an accelerometer coupled to the oscillator for measuring frequency and acceleration of oscillation of the oscillator. The stimulator further includes a controller user interface for receiving user input regarding a desired frequency and acceleration of oscillation of the oscillator. The stimulator further includes a controller coupled to the oscillator and the accelerometer for receiving measurements of frequency and acceleration of oscillation of the oscillator from the accelerometer and controlling the frequency and acceleration of oscillation of the oscillator to minimize a difference between the desired frequency and acceleration of oscillation of the oscillator and the frequency and acceleration of oscillation measured by the accelerometer. The stimulator further includes means for securing the frame to the subject so that the oscillator is wearable.

### PRIORITY CLAIM

This application claims the priority benefit of U.S. Provisional Patent Application Ser. No. 63/005,029 filed Apr. 3, 2020, the disclosure of which is incorporated herein by reference in its entirety.

### GOVERNMENT INTEREST

This invention was made with government support under Grant Number W81XWH-15-1-0287 awarded by the Department of Defense. The government has certain rights in the invention.

### TECHNICAL FIELD

The subject matter described herein relates to vibratory stimulation of muscles for rehabilitation of orthopaedic injuries and disease.

### BACKGROUND

In the fields of rehabilitation of orthopaedic injuries and disease, it is desirable to stimulate muscle and sensory functions related to joints to increase the effectiveness of the rehabilitation and reduce behaviors that could lead to degradation of joint function. Some injuries, such as anterior cruciate ligament (ACL) injuries, disrupt sensory information that is sent to the central nervous system and alter the drive/motor output from the nervous system to the quadriceps muscle. Because the graft that is used to reconstruct the ACL does not restore the native sensory function and possibly because of learned maladaptive behaviors, this scenario can persist for years following injury and surgery. Because the quadriceps muscle is critical for attenuating forces during routine activities, such as walking, declines in the function of this muscle are thought to contribute to altered loading of joint tissues (e.g., cartilage) and high risk of knee osteoarthritis following knee injuries.

Applying vibratory stimulation combination with rehabilitation has been shown to improve the effectiveness of physical rehabilitation. However, some conventional vibratory stimulation devices are hand held and must be applied by the clinician while the patient is stationary. Such devices are unable to be used while the patient is participating in rehabilitation activities.

Another type of conventional vibratory stimulator device delivers vibration to the patient via a concentrated tip applicator with a small contact area (e.g., point stimulators) that is best suited for isolated stimulation of muscle spasms/trigger points and small muscles (e.g., in the hand). Such devices are unsuitable for rehabilitating large muscles, such as the quadriceps.

Yet another problem with conventional vibratory stimulators is the inability to easily adjust parameters, such as frequency, acceleration, and duration of vibratory stimulation. The inability to adjust these parameters makes such devices less suitable for targeted therapy.

Accordingly, in light of these difficulties, there exists a need for a wearable local muscle vibration stimulator that is adjustable and suitable for applying vibratory stimulus to large muscles, such as the quadriceps.

### SUMMARY

A wearable local muscle vibratory stimulator includes a frame including a concave surface for conforming to a treatment surface of a subject. The stimulator further includes an electromagnetic oscillator located in the frame for applying vibratory stimulus to the treatment region of the subject located beneath the treatment surface. The stimulator further includes a waveform generator coupled to the oscillator for generating an electrical signal that causes the electromagnetic oscillator to oscillate. The stimulator further includes an accelerometer coupled to the oscillator for measuring frequency and acceleration of oscillation of the oscillator. The stimulator further includes a controller user interface for receiving user input regarding a desired frequency and acceleration of oscillation of the oscillator. The stimulator further includes a controller coupled to the oscillator and the accelerometer for receiving measurements of frequency and acceleration of oscillation of the oscillator from the accelerometer and controlling the frequency and acceleration of oscillation of the oscillator to minimize a difference between the desired frequency and acceleration of oscillation of the oscillator and the frequency and acceleration of oscillation measured by the accelerometer. The stimulator further includes means for securing the frame to the subject so that the oscillator is wearable.

The subject matter described herein may be implemented in hardware, software, firmware, or any combination thereof. As such, the terms “function” “node” or “module” as used herein refer to hardware, which may also include software and/or firmware components, for implementing the feature being described. In one exemplary implementation, the subject matter described herein may be implemented using a computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

FIG. 1A is an image of a wearable local muscle vibratory stimulator;

FIG. 1B is an image of the wearable local muscle vibratory stimulator of FIG. 1 illustrating a printed circuit board and battery components;

FIG. 2 is an image of a closeup view of a frame for a wearable local muscle vibratory stimulator;

FIGS. 3A and 3B are images of an electromagnetic oscillator for a local muscle vibratory stimulator;

FIG. 4 is an image of a printed circuit board for a local muscle vibratory stimulator;

FIG. 5 is a drawing of a computer screen shot of a graphical user interface for controlling operation of a local muscle vibratory stimulator;

FIGS. 6A and 6B are images of a subject wearing a local muscle vibratory stimulator;

FIG. 7 is a bottom perspective view of an oscillator holder of a frame for a local muscle vibratory stimulator;

FIG. 8 is a top perspective view of an oscillator holder of a frame for a local muscle vibratory stimulator;

FIG. 9 is a bottom perspective view of an accelerometer holder for a frame for a local muscle vibratory stimulator;

FIG. 10 is a top perspective view of an accelerometer holder for a frame for a local muscle vibratory stimulator;

FIGS. 11A and 11B are perspective views of an alternate implementation of a local muscle vibratory stimulator illustrating different control and measurement communications interfaces and frame configurations;

FIG. 12 is a perspective view of an alternate implementation of a local muscle vibratory stimulator illustrating different control and measurement communications interfaces and different accelerometer locations;

FIG. 13 is a block diagram illustrating exemplary electronic components of a local muscle vibratory stimulator;

FIG. 14 is a schematic diagram illustrating electrical connections between components of a local muscle vibratory stimulator; and

FIG. 15 is a flow chart illustrating exemplary steps for using a local muscle vibratory stimulator during physical rehabilitation or exercise.

### DETAILED DESCRIPTION

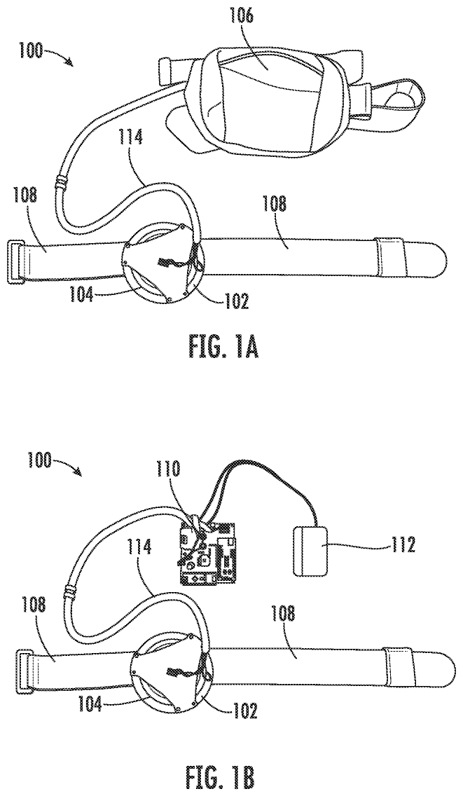

The subject matter described herein includes a wearable local muscle vibratory stimulator. FIG. 1A is an image of a prototype implementation of a local muscle vibratory stimulator. In FIG. 1A, a local muscle vibratory stimulator 100 includes a frame 102 holding an electromagnetic oscillator 104 that oscillates to deliver vibratory stimulus to a subject via the frame. This vibratory stimulus is similar to the mechanics of a reflex hammer when evaluating the tendon-tap/knee-jerk reflex clinically in that it creates rapid changes in quadriceps length, thus exciting the muscle via the muscle spindle system.

A wearable bag 106 contains control circuitry for controlling oscillator 104. Straps 108 are threaded through frame 102 for attaching frame 102 to a subject so that stimulator 100 can be worn by the subject and operated while the subject is participating in physical rehabilitation activities. In one example, straps 108 may be sized to secure frame 102 to a subject's thigh for enhancing rehabilitation of a quadriceps muscle.

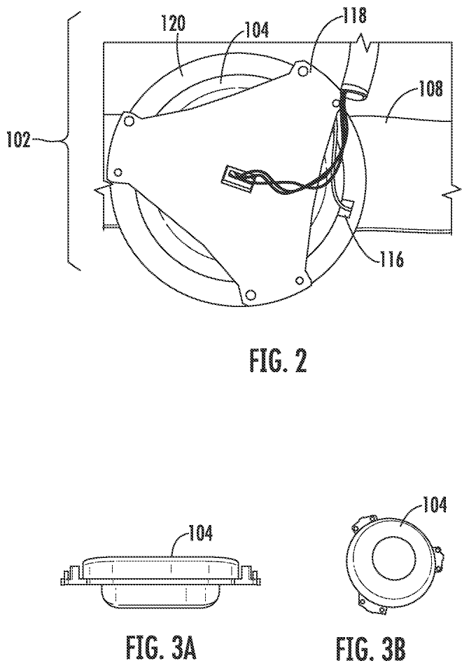

FIG. 1B illustrates stimulator 100 of FIG. 1A with control unit circuit board 110 and power supply 112 removed from bag 106. Control unit circuit board 110 includes components for controlling oscillations of oscillator 104. In the illustrated example, a wired connection 114 connects control unit circuit board 110 to oscillator 104 and to an accelerometer 116. Accelerometer 116 measures the frequency and acceleration of oscillation of oscillator 104. FIG. 2 is a closeup view of frame 102, oscillator 104, and accelerometer 116. In the illustrated example, frame 102 includes an accelerometer holder 118 and an oscillator holder 120.

FIGS. 3A and 3B are images of electromagnetic oscillator 104. In the illustrated example, electromagnetic oscillator 104 is an audio speaker. However, the subject matter described herein is not limited to using an audio speaker. Any oscillator capable of generating and delivering vibratory stimulus to a subject along a single axis is intended to be within the scope of the subject matter described herein.

FIG. 4 is an image of control unit circuit board 110 of the prototype implementation illustrated in FIGS. 1A, 1B, and 2. Control unit circuit board 110 includes a controller, an amplifier, and a waveform generator, the operation of which will be described in detail below. In addition, although in the examples illustrated in FIGS. 1A and 1B, control unit circuit board 110 is separate from frame 102, the subject matter described herein is not limited to such an implementation. In an alternate implementation, control unit circuit board 110 and the components mounted on control unit circuit board 110 as well as power supply 112 may be miniaturized and attached to or incorporated within frame 102.

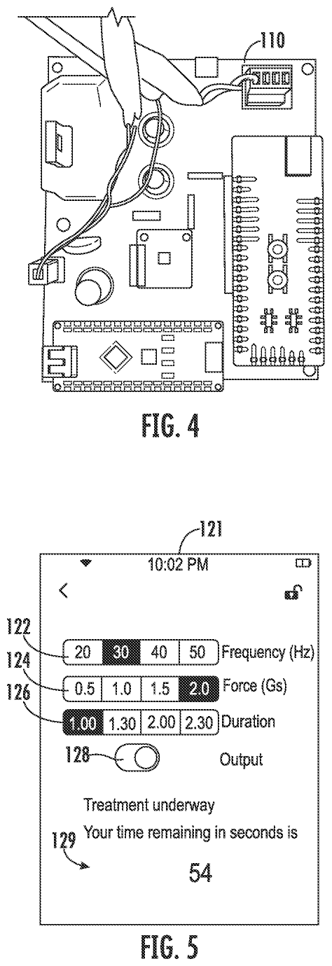

FIG. 5 is a diagram illustrating a controller user interface for varying frequency, force, and duration of oscillations by oscillator 104. In the illustrated example, controller user interface 121 includes a first graphical tool 122 for controlling frequency, a second graphical tool 124 for controlling acceleration, a third graphical tool 126 for controlling duration of treatment, and a fourth graphical tool 128 for activating and deactivating oscillator 104. Controller user interface 121 further includes a treatment status display area 129 that displays an indication that treatment is in progress and that includes a timer that indicates an amount of time remaining in the current treatment.

In one example, controller user interface 121 is displayable on a user's mobile device. As such, control unit circuit board 110 may include a communications interface, such as a Bluetooth interface, for connecting to the user's mobile device so that controller user interface 121 may be used to remotely provide control input to a controller for controlling frequency and acceleration of oscillation of oscillator 104. For example, a physician or physical therapist may use controller user interface 121 to set and vary frequency, force or acceleration, and duration of oscillations by oscillator 104 while the subject is participating in physical rehabilitation or exercise activity.

The input received via controller user interface 121 will be provided as desired input to the controller. The frequency and acceleration of oscillation by oscillator 104 measured by accelerometer 116 will be provided as measurement input to the controller. The controller will generate a control signal to oscillator 104 to minimize a difference or error between the desired frequency and acceleration of oscillation and the measured frequency and acceleration of oscillation.

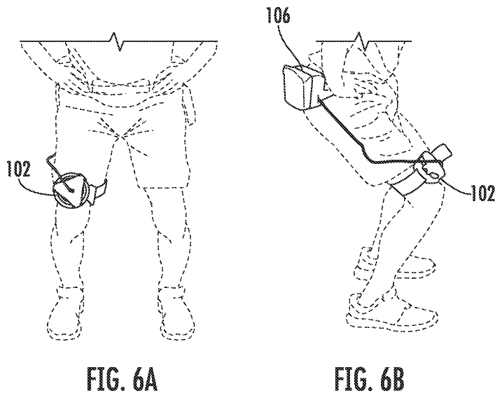

FIGS. 6A and 6B illustrate the wearing of vibratory stimulator 100 by a human subject during physical exercise and/or rehabilitation activity. In the illustrated example, vibratory stimulator 100 is secured to the subject's thigh for applying vibratory stimulus to the subject's quadriceps muscle. Bag 106 containing the control electronics is secured to the subject's waist.

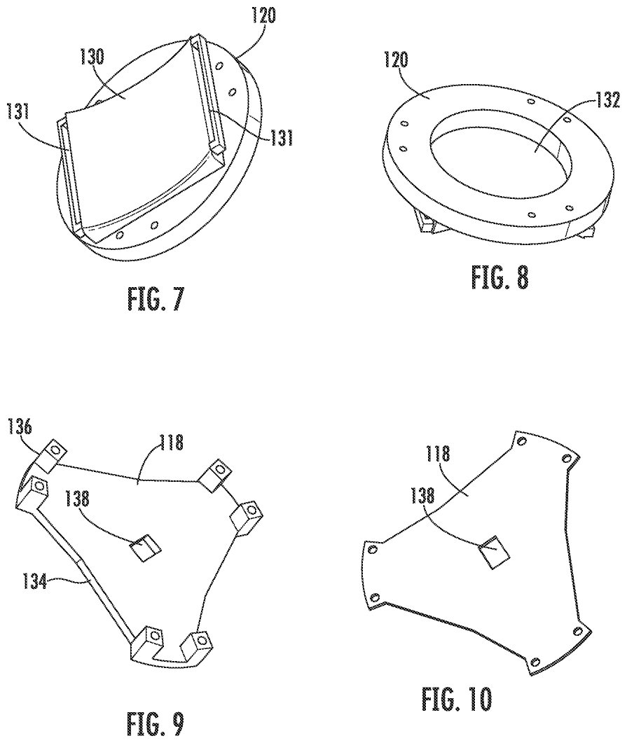

FIG. 7 is a bottom perspective view of oscillator holder 120. In FIG. 7, oscillator holder 120 includes a concave surface 130 for conforming to a surface of a subject's thigh. Oscillator holder 120 further includes strap guides 131 to which straps 108 are secured. In use, concave surface 130 is worn transversally with respect to the long axis of the quadriceps muscle. Vibratory stimulation is delivered mechanically through concave surface 130 into the subject's muscle.

FIG. 8 illustrates a top perspective view of oscillator holder 120 where oscillator holder 120 includes a central recess 132 for holding oscillator 104 (not shown in FIG. 8). When oscillator 104 is positioned in recess 132, vibrations generated by oscillator 104 are transferred via mechanical conduction through concave surface 130 into the subject's thigh. In one example, oscillator 104 delivers vibratory stimulation along a single axis in the anterior-posterior direction with regard to the muscle being treated.

FIG. 9 is a bottom perspective view of accelerometer holder 118, and FIG. 10 is a top perspective view of accelerometer holder 118. In FIG. 9, accelerometer holder 118 includes a plate 134 that is securable to oscillator holder 120 via tabs 136 through which fasteners, such as screws, are inserted. Plate 134 also includes a central aperture 138 for holding an accelerometer or for allowing a connector to connect to corresponding pins or sockets for communicating control signals to oscillator 104.

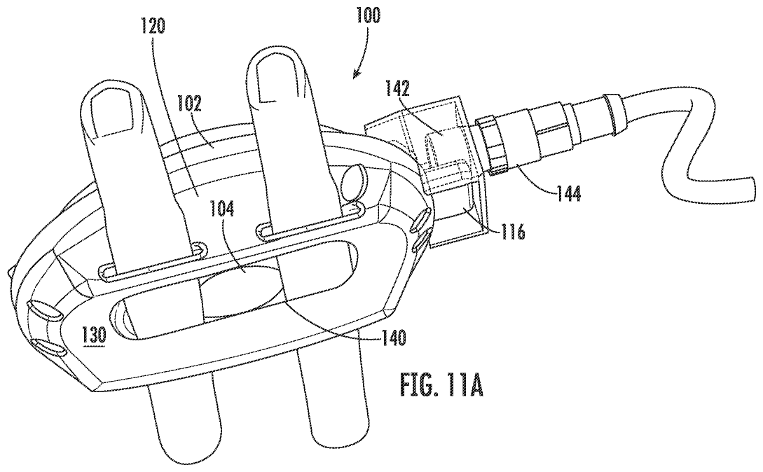

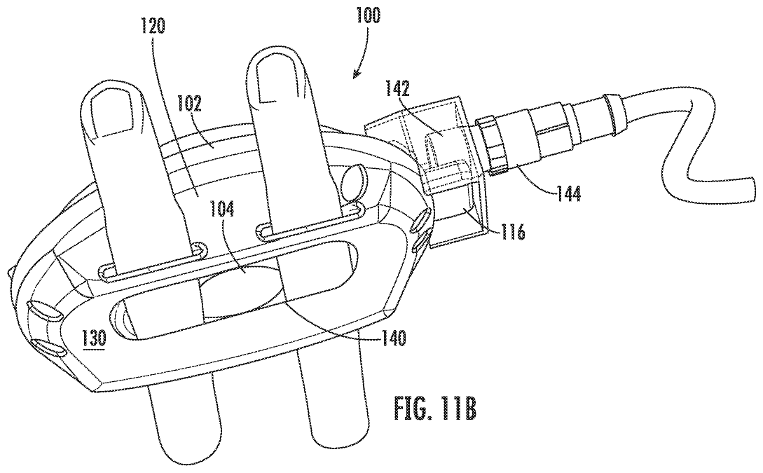

FIGS. 11A and 11B illustrate an alternate implementation of local muscle vibratory stimulator with a different frame configuration and a different control and measurement communication interface from the prototype implementation illustrated in FIGS. 1A and 1B. In FIG. 11A, concave lower surface 130 of oscillator holder 120 includes a central aperture 140 to reduce the weight of local muscle vibratory stimulator and to allow direct contact between oscillator 104 and the subject. In addition, local muscle vibratory stimulator 100 includes a communication interface 142 for communicating control signals to oscillator 104 and for communicating measurement signals from accelerometer 116 to controller printed circuit board 110. In the illustrated example, communication interface 142 is a female connector for connecting to a male 9-pin audio connector 144. Using a single communication interface for communicating control signals to oscillator 104 and measurement signals from accelerometer 116 reduces the weight and complexity of stimulator 100 over implementations with separate communication interfaces for control and measurement signals.

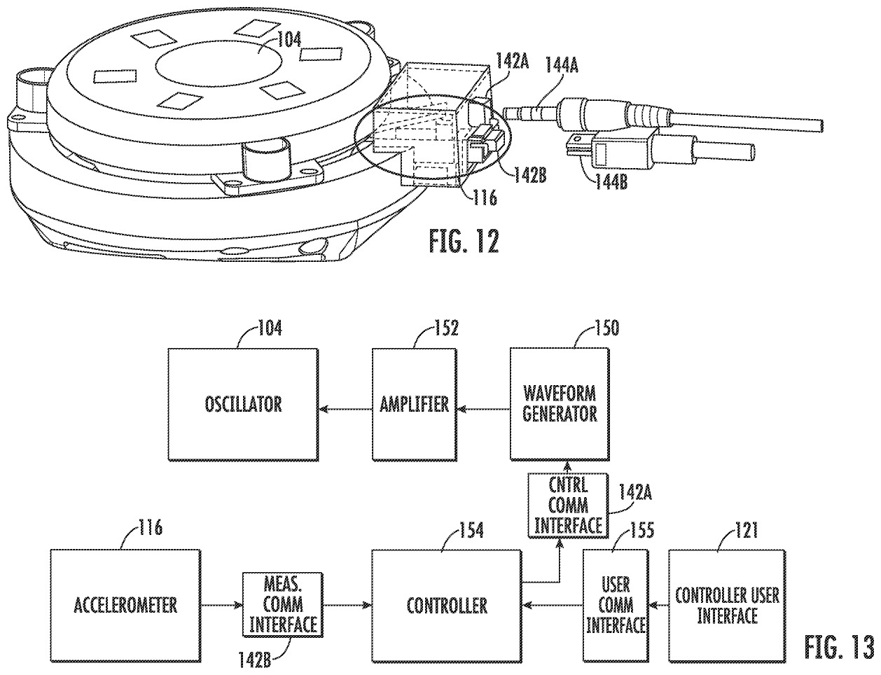

FIG. 12 illustrates an alternate implementation of local muscle vibratory stimulator 100 with separate communication interfaces for measurement and control signals and alternate locations for accelerometer 116. In FIG. 12, local muscle vibratory stimulator 100 includes control communication interface 142A for connecting to a control signal connector 144A and a measurement communication interface 142B for connecting to a measurement communications connector 144B. In the illustrated example, control communication interface 142A is a female ¼ inch audio connector for connecting to male ¼ inch audio connector, and measurement communication interface 142B comprises a female USB connector for connecting to a male USB connector.

FIG. 12 also illustrates alternate locations for accelerometer 116. In FIG. 12, accelerometer 116 is located on an outside edge of frame 102. In an alternate implementation, indicated by the red arrow in FIG. 12, accelerometer 116 may be located at or near the center of accelerometer holder 118 adjacent to the center of oscillator 104.

FIG. 13 is a block diagram illustrating exemplary electronic components of wearable local vibratory muscle stimulator. In FIG. 13, the components include oscillator 104, an accelerometer 116 previously described. A waveform generator 150 provides an electronic signal for controlling oscillation of oscillator 104. An amplifier 152 amplifies a signal output from waveform generator 150 to a level suitable for inducing vibrations of oscillator 104. In one example, amplifier 152 may be an audio amplifier. A controller 154 receives frequency and acceleration measurements from accelerometer 116 as well as control input from user interface 121. Controller 154 provides output to waveform generator 150 to control the frequency and acceleration of oscillation based on the control inputs.

FIG. 13 also illustrates measurement communication interface 142B connecting accelerometer 116 to controller 154, and control communication interface 142A for connecting amplifier 152 to oscillator 104. A user control communication interface 155 may be provided to communicate control signals between controller user interface 121 and controller 154. In one example, user control communication interface 155 may be a wireless interface, such as a Bluetooth interface.

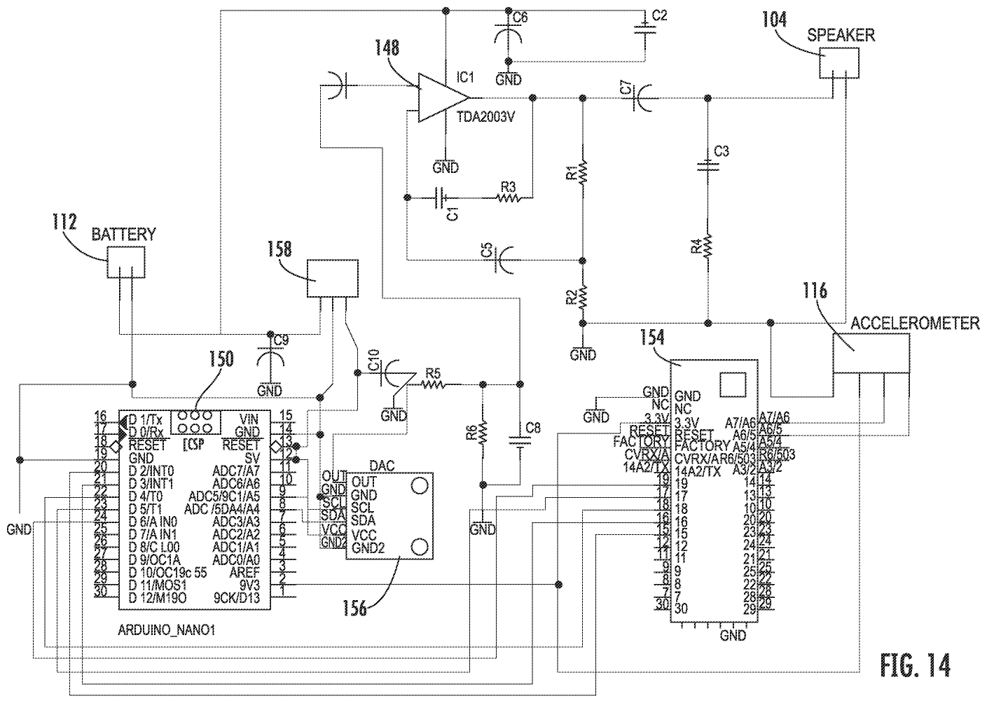

FIG. 14 is an electrical schematic diagram of the electronic components of the local muscle vibratory stimulator. In the illustrated example, power supply 112 supplies energy to the various electronic components. A voltage regulator 158 regulates the voltage output from power supply 112. Waveform generator 150 provides a signal that is output via a digital to analog converter (DAC) 156 to amplifier 152. The output signal from amplifier 152, which in the illustrated example is an operational amplifier, is used to drive oscillator 104. In one example, the signal used to drive oscillator 104 is a sine wave with a frequency and acceleration set based on control and measurement inputs to controller 154. Controller 154 provides control input to waveform generator 150 based on measurements received from accelerometer 116 and control inputs received from controller user interface 121 (not shown in FIG. 14).

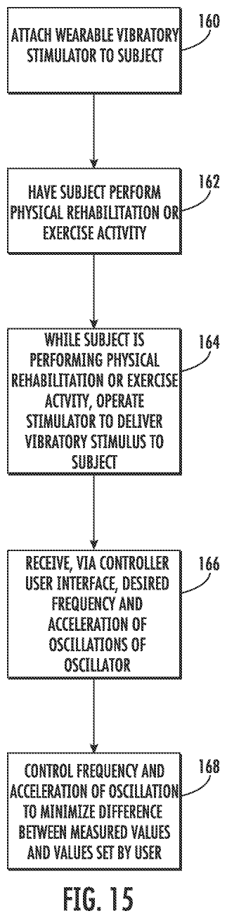

FIG. 15 is a flow chart illustrating an exemplary process for using wearable local muscle vibratory stimulator 100 to delivery vibratory stimulus to a subject while the subject is participating in physical rehabilitation and/or exercise activity. Referring to FIG. 15, in step 160, wearable local muscle vibratory stimulator 100 is attached to a subject. For example, frame 102 may be attached to a treatment surface of a subject by securing frame 102 to the treatment surface via straps 108.

In step 162, the process includes having the subject perform physical rehabilitation or exercise activity. In step 164, the process includes, while the subject is performing the physical rehabilitation or exercise activity, operating the stimulator to deliver vibratory stimulation to the subject. For example, a physician or physical therapist may activate, via controller user interface 121, stimulator 100 to deliver vibratory stimulus to the treatment region beneath the treatment surface of the subject while the subject is participating in physical rehabilitation or exercise activity.

In step 166, the process includes receiving, via the controller user interface, desired frequency and acceleration of oscillations of oscillator 104 to enhance the therapeutic benefits of the physical rehabilitation or exercise activity. For example, the physician or physical therapist may utilize graphical tool 122 to set the frequency of oscillations of oscillator 104 and graphical tool 124 to set the acceleration of oscillations of oscillator 104.

In step 168, the process includes controlling the frequency and acceleration of oscillation of the oscillator to minimize a difference in the frequency and acceleration of oscillation set by the user and the frequency and acceleration of oscillation measured by the accelerometer. For example, controller 154 may receive control input from controller user interface 121 and measurements from accelerometer 116 and produce an output signal to waveform generator 150 to minimize an error or difference between the desired frequency and acceleration of oscillation of oscillator 104 and the measured frequency and acceleration of oscillation of oscillator 104.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. A wearable local muscle vibratory stimulator comprising:
a frame including a concave surface for conforming to a treatment surface of a subject;
an electromagnetic oscillator located in the frame for applying vibratory stimulus to a treatment region of the subject located beneath the treatment surface;
a waveform generator coupled to the oscillator for generating an electrical signal that causes the electromagnetic oscillator to oscillate;
an accelerometer coupled to the oscillator for measuring frequency and acceleration of oscillation of the oscillator;
a controller user interface for receiving user input regarding a desired frequency and acceleration of oscillation of the oscillator a controller coupled to the oscillator and the accelerometer for receiving measurements of frequency and acceleration of oscillation of the oscillator from the accelerometer and controlling the frequency and acceleration of oscillation of the oscillator to minimize a difference between the desired frequency and acceleration of oscillation of the oscillator and the frequency and acceleration of oscillation measured by the accelerometer; and
means for securing the frame to the subject so that the oscillator is wearable.

2. The stimulator of claim 1 wherein the frame includes an oscillator holder and an accelerometer holder.

3. The stimulator of claim 2 wherein the oscillator comprises a speaker and the oscillator holder includes a central recess for holding the speaker.

4. The stimulator of claim 2 wherein the oscillator comprises a speaker and the oscillator holder includes a central aperture for allowing the speaker to directly contact the treatment surface.

5. The stimulator of claim 1 wherein the oscillator comprises a single axis oscillator for applying vibratory stimulus to the treatment surface along a single axis.

6. The stimulator of claim 2 wherein the accelerometer is located on an outer edge of the oscillator holder.

7. The stimulator of claim 2 wherein the accelerometer is located at or near a center of the oscillator holder adjacent to a center of the oscillator.

8. The stimulator of claim 1 wherein the means for holding includes at least one strap and the frame includes strap guides located on opposite ends of the concave surface.

9. The stimulator of claim 1 wherein the controller user interface comprises a graphical user interface including graphical tools for varying the frequency and acceleration of the oscillation.

10. The stimulator of claim 9 wherein the graphical user interface is displayable on a mobile device and wherein the stimulator further comprises a user control communication interface for receiving control input from the user via the graphical user interface and for communicating the control input to the controller.

11. The stimulator of claim 10 wherein the user control communication interface comprises a wireless communication interface.

12. The stimulator of claim 1 comprising a control communication interface for communicating control signals from the controller to the waveform generator and a measurement communication interface for communicating the measurements from the accelerometer to the controller.

13. The stimulator of claim 12 wherein the control communication interface and the measurement communication interface comprise a single connector.

14. The stimulator of claim 12 wherein the control communication interface and the measurement communication interface comprise separate connectors.

15. The stimulator of claim 1 comprising an amplifier coupled to the waveform generator, the controller, and the oscillator for controlling the acceleration of oscillations of the oscillator.

16. The stimulator of claim 1 comprising a controller printed circuit board, wherein the controller and the waveform generator are located on the printed circuit board.

17. The stimulator of claim 16 wherein the controller printed circuit board is separate from the frame and the stimulator further comprises a bag for holding the controller printed circuit board and means for securing the bag to the subject.

18. The stimulator of claim 16 wherein the controller printed circuit board is attached to or integrated within the frame.

19. The stimulator of claim 2 wherein the accelerometer holder includes a central aperture for allowing passage of a connector for connecting to the accelerometer.

20. A method for applying vibratory stimulus to a subject during physical rehabilitation or exercise, the method comprising:
attaching a wearable vibratory stimulator to a subject, the wearable vibratory stimulator including an oscillator for oscillating with a frequency and acceleration to deliver vibratory stimulus to a treatment region of a subject;
while the subject is performing physical rehabilitation or exercise wearing the vibratory stimulator, causing the oscillator to oscillate and deliver vibratory stimulus to a treatment region of the subject;
measuring, using an accelerometer, the frequency and acceleration of oscillation of the oscillator;
receiving, from a controller user interface, using input regarding a desired frequency and acceleration of oscillation of the oscillator; and
controlling, using a controller, the frequency and acceleration of oscillation of the oscillator to minimize a difference between the frequency and acceleration of oscillation measured by the accelerometer and the desired frequency and acceleration of oscillation received via the controller user interface.
